(19) United States
(12) Patent Application Publication
(10) Pub. No.: US 2018/0003146 A1
(43) Pub. Date: Jan. 4, 2018

(54) METHOD AND SYSTEM FOR ADJUSTING THE TORQUE OF A MASS AND SPINNING WHEEL ROTATOR IN A WAVE POWER PLANT

(71) Applicant: WELLO OY, Espoo (FI)

(72) Inventor: Antti PAAKKINEN, Espoo (FI)

(73) Assignee: WELLO OY, Espoo (FI)

(21) Appl. No.: 15/541,873

(22) PCT Filed: Dec. 17, 2015
(86) PCT No.: PCT/FI2015/050894

§ 371 Date: Jul. 6, 2017

(30) Foreign Application Priority Data
Jan. 9, 2015 (FI) 20155011

(51) Int. Cl. F03B 13/16; F03B 15/00; G05B 15/02

(52) U.S. Cl. CPC F03B 13/16; G05B 15/02; F03B 15/00; F05B 2270/101

(57) ABSTRACT

The invention relates to a method and a system for adjusting the torque of a mass and spinning wheel rotator in a wave power plant. The torque of a rotator rotating around a vertical shaft is compensated partially or completely with a compensating moment which is produced by an electric machine. Acceleration components (^{ACC}x and ^{ACC}y) are measured for a given point of the wave power plant's floating body (1) in directions perpendicular to each other. A vector (V_{xy}) with a magnitude formula (A) and a direction (a_{Acc}) is established for said acceleration components, the direction or angular position (a) of a rotator (2) is monitored and its lag (α_{LAG}) from the acceleration vector's direction (α_{Acc}) is determined. The compensating moment is adjusted as dependent on a compensation factor (B) whose sub-factors are the magnitude of the body's acceleration vector (V_{xy}) and the sine of the angle of lag (sin α_{LAG}). This is supplemented with a compensation factor based on spinning wheel forces in a manner otherwise similar except that the acceleration must be replaced with a rotation speed (AV_{x-y}) of the body's inclination, which is obtained from an inertial sensor 821). and the mass must be replaced with a gyro force which is dependent on the inertia and rotating speed of a spinning wheel.

The invention relates to a method and a system for adjusting the rotator of a wave power plant in terms of is torque. The torque of a rotator which rotates around a vertical shaft is partially or fully compensated for with a moment generated by an electric machine.

The Applicant's earlier international patent application WO2013/156674 A2 discloses one solution for optimizing the coordination of body inclinations and moments. There, the body has been fashioned as a vertical or inclined wall submerged to a sufficient depth. By making use of the internal flows of a wave there is established such a stage in the body's tilting that the moment induced by horizontal acceleration can also be exploited. This is not possible with bodies that are floating by complying with the direction of a wave surface. The moments generated by inclination and acceleration are now summed up into a dead mass torque. In the event of using a spinning wheel, the torque generated by the spinning wheel and the torque generated by the dead mass alternate during a revolution of the rotator and each torque works twice during the revolution, thereby producing torques repeated typically at intervals of about 90° and striving to rotate the rotator in the same direction of rotation. This arrangement is beneficial with bodies that are long in horizontal direction.

The Applicant's earlier international applications WO2014/001627 A1 and WO2015/040277 A1 disclose a type of wave power plant, wherein the body has a horizontal length in the same size range as its height. In this case, the operation can be further enhanced with arrangements by which the body is set in gyrating motion, i.e. the inclination of a rotator shaft is enabled to revolve around a theoretical vertical axis as opposed to the rotator shaft tilting back and forth. Thus, the rotator-turning moment by inclination is always available. Likewise, the spinning wheel-generated moment is continuous over the entire revolution. It is prior known to regulate the compensating moment by adjusting the load of an electric machine such as a generator. However, the torque to be compensated for fluctuates non-linearly and in a manner difficult to anticipate. This makes the compensation adjustment challenging and the adjustment equipment complicated and expensive.

It is an objective of the invention to provide a method and a system by means of which the moment can be adjusted in a simpler, easier and more effective manner than before, thereby improving the operating reliability and performance output of a wave power plant while simplifying the adjustment system. A particular objective of the invention is also to enable the addition of a compensation factor based on spinning wheel forces to a compensation factor determined on the basis of mass forces.

This objective is attained with a method of the invention on the basis of features presented in the appended claim 1. The objective is also attained by means of the system features presented in claim 8. Preferred embodiments of the invention are presented in the dependent claims.

The method and system of the invention are particularly applicable for a wave power plant which is capable of generating as clean a gyration motion as possible for the rotator shaft. The combination of a gyrating motion as defined and a moment adjustment of the invention can be used to enable a continuous rotary motion and continuous energy production even in irregular wave. In other words, the invention can be used for improving the output performance and working capabilities of a wave power plant in a multitude of varying wave conditions.

Hence, it has been realized in the invention to create conditions for the adjustment of a compensating moment, e.g. in such a way that the rotation speed of a rotator can be maintained relatively constant, making it easy to synchronize the rotation speed with the existing wave conditions. The invention is particularly suitable for wave power plants, wherein tilting of the body plane occurs simultaneously both in a direction perpendicular to the plane and in a direction parallel to the plane, the combined motion thereby generating a gyration motion. In this context, the gyration motion refers to a conical motion path of the rotator shaft with the cone having a cross-section other than circular form, e.g. oval. As a result, the body and the rotator shaft have the inclination direction thereof revolving or rotating around a vertical axis principally in the rotating direction in response to the flows of waves. The period of waves determines a rotation speed for the body's tilting direction.

In addition, the invention also enables the utilization of a benefit disclosed in the Applicant's earlier patent application WO2013/156674 A2, namely that tilting and horizontal accelerations coincide with each other in such a phase that the moments of inclination/gravity and motion acceleration strengthen each other. In addition, the moment of a spinning wheel force can be utilized as a rotation equalizer for the rotator as desired. The result of this is a high and relative consistent moment and a high output performance.

The wave power plant provided with a compensating moment adjustment of the invention generates power at a high efficiency and in a fairly consistent manner irrespective of the wave size, because the length/height dimensions of typical natural waves are more or less constant.

The invention will now be illustrated and described even more precisely with reference to the accompanying drawings, in which:

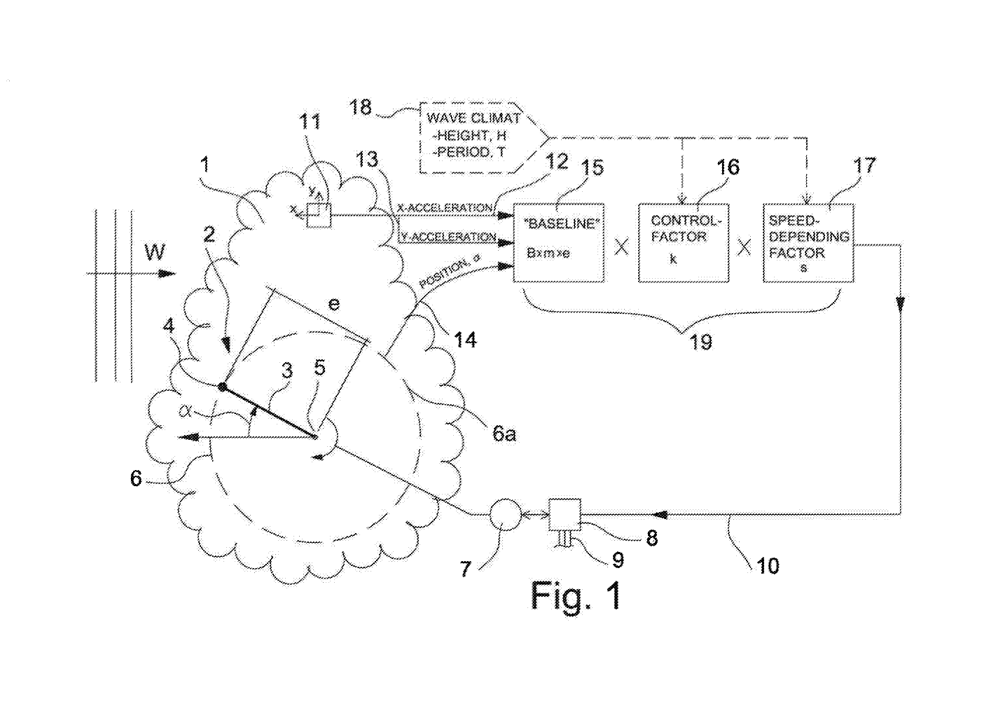

FIG. 1 shows a system diagram for executing a method of the invention;

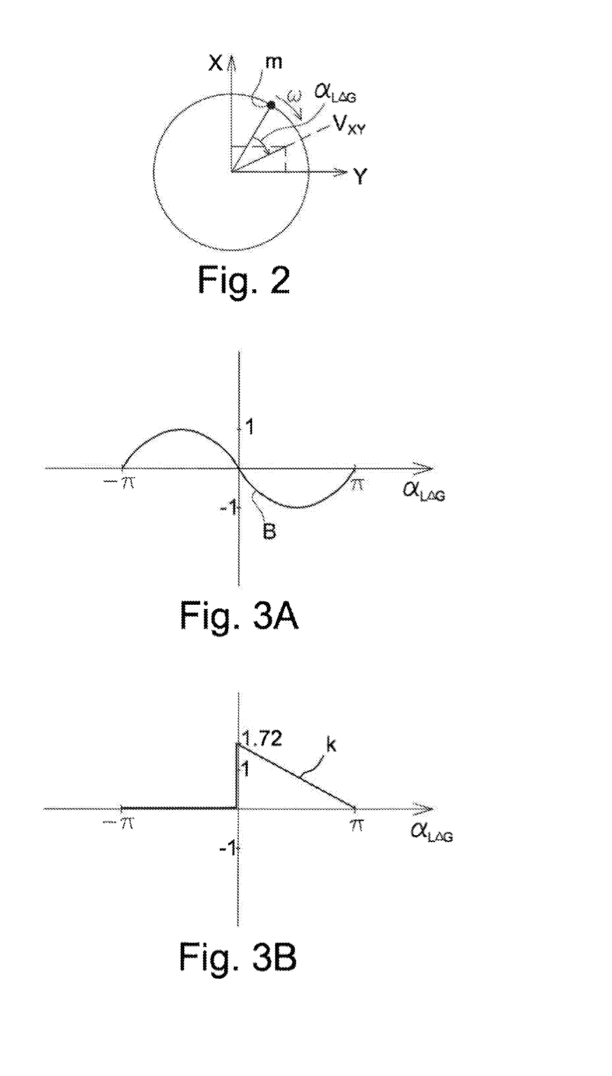

FIG. 2 illustrates the application of an adjustment of the invention to a rotator in the system of FIG. 1;

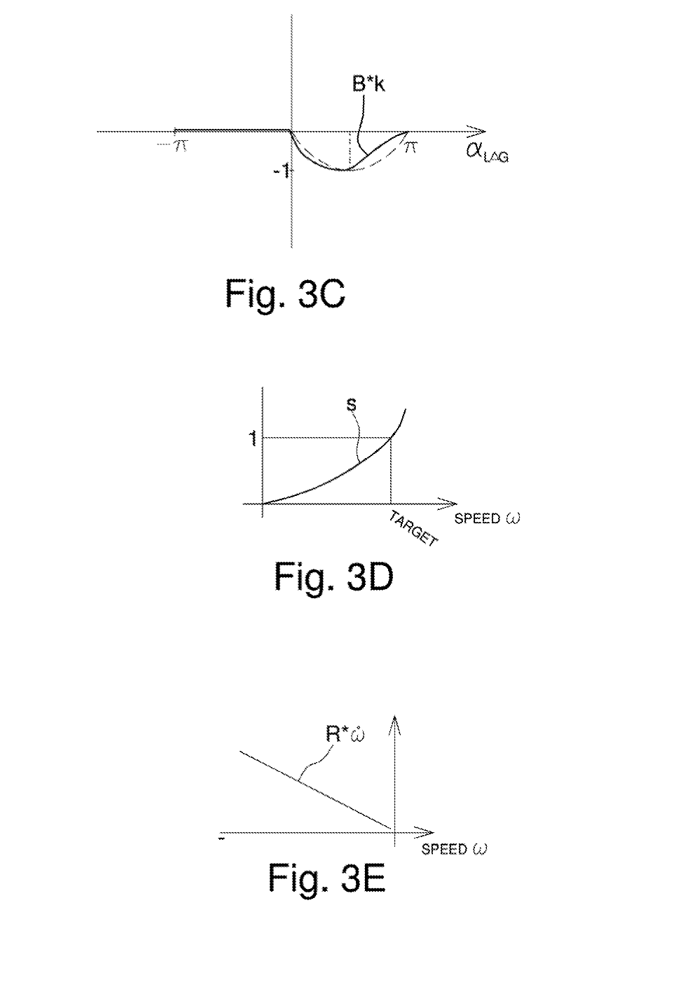

FIG. 3A shows an adjustment graph or compensation factor B for a fully compensating moment as a function of rotator lag as the rotator lag from the acceleration vector of FIG. 2 is within an angular range of −PI −PI;

FIG. 3B shows one ramp k which can be used for multiplying the lag in case it is desired that the wave power plant is generating, i.e. the rotator has an angle of lag which is positive;

FIG. 3C shows a compensation graph determined according to a lag multiplied by the factor of FIG. 3B;

FIG. 3D shows an additional multiplication factor (S), which depends on the rotator's angular velocity and by which the compensation factor B can be multiplied for keeping the rotator speed close to a target speed, i.e. the speed corresponding to an average wave period;

FIG. 3E shows one ramp which is used for prohibiting the rotation of a rotator in a negative direction;

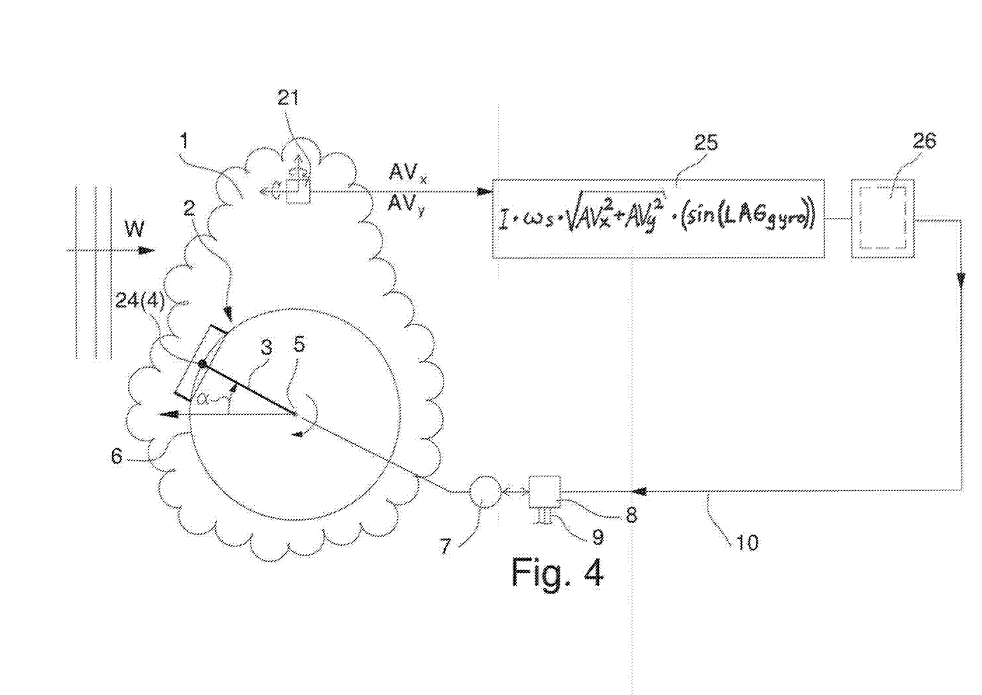

FIG. 4 shows a system diagram similar to that of FIG. 1, relating to the compensation of a wlywheel section.

In FIG. 1 is shown one preferred implementation for an adjustment system of the invention in a schematic view of principle. A rotator 2 and a body 1 can be structurally of any prior known type, for example of the type described in the above-cited applications. Not constituting an object of this invention, these are not discussed any further.

The vertical dimension of a submerged portion of the body 1 is typically larger than the horizontal dimension of the cross-section. Preferably, more than 80% of the body's height is under water and the body 1 is dimensioned to extend in vertical direction to such a depth at which wave motion is substantially present. The body 1 floats on water and is moored in such a way that when the body is contacted by a wave front W, the body either swings back and forth or performs a gyrating motion.

The rotator 2 is supported on the body so as to rotate around a vertical shaft 5. The rotator includes an arm 3 one end of which is mounted with bearings on the vertical shaft and the other end carries a heavy mass 4 having its mass denoted with the letter m. The mass 4 circulates along a path 6 e.g. in a clockwise direction. The rotator 2 drives a generator 7 which feeds electric power to an output line 9 by way of a converter 8. The rotator produces a moment to be compensated, which should be adjusted for making the rotator's angular position and angular velocity favorable with respect to movements of the body. The difference between the direction of the body's acceleration vector and the direction of the rotator is what generates a torque for the rotator shaft 5.

In this arrangement, the rotator 2 is able to make use not only a rotating moment produced by the body's inclination (gyration) and by gravity but also a moment produced by horizontal accelerations, i.e. by an acceleration vector projected onto a plane of rotation of the rotator. The acceleration in a pitch direction is parallel to the wave propagation direction. At the time of maximum acceleration, with a phase angle between the rotator's direction and the acceleration vector being as it should be (preferably 30-90 degrees), this moment works in a timely fashion in a right direction.

An acceleration sensor 11 is located to be essentially flush with the trajectory 6 of the rotator 2, e.g. adjacent to the trajectory or in the proximity of the vertical shaft 5. The acceleration sensor 11 is preferably a 3D acceleration sensor used for measuring accelerations in x, y and z directions and, regarding the spinning wheel rotator (FIG. 4), an acceleration and inclination speed sensor 21 (inertial sensor). Acceleration data and information about the rotator's angular position are transferred by way of signal paths 12, 13 and 14 into a block 15 included in a signal processing unit 19, with a compensating moment being calculated therein for basic adjustment.

For the basic adjustment, accelerations ACCₓ and ACC_{y} for a given point of the body 1 will be measured in directions perpendicular to each other, which are codirectional with a track plane of the rotator, and there will be established a vector V_{xy} of the measured accelerations which has a magnitude \sqrt{ACCₓ²+ACC_{y}²}and a direction α_{ACC}. There is further monitored a direction of the rotator 2, i.e. an angular position α, and its lag α_{LAG} is determined from the direction α_{Acc} of the acceleration vector V_{xy}. By means of this information is determined a compensation factor B which can be used for adjusting the compensating moment. Sub-factors for the compensation factor B include the magnitude of the acceleration vector V_{xy} and the sine of the angle of lag (sin α_{LAG}).

Thus, the compensation factor B is obtained from a formula

B=\sqrt{ACCₓ²+ACC_{y}²}·sin α_{LAG} (1)

In FIG. 3A is illustrated a relationship between the thereby established compensation factor B (basic adjustment graph/Baseline) and the lag α_{LAG}. Therefore, the rotator lag can be always represented as an angle within the range of −pi −pi. The compensation factor B is zero as the sign changes at +/− pi.

When considering a mass m of the rotator and a length e of the arm 3, the result is a useful com pensating moment

T_{comp}=B·m·e (2)

The use of this compensating moment T_{comp} in an electric machine, such as in a generator 7, enables a partial or full compensation for the rotator torque. In the system of FIG. 1, the compensation factor B and the compensating moment (formula 2) are calculated in the unit 15 on the basis of sensor data.

If the compensation factor B is used as such, i.e. with a 100% effect, the compensating moment strives to keep the rotator's speed of rotation unchanged, even though the body's acceleration should fluctuate.

The compensation factor B can be multiplied with a factor (FIG. 3B), whereby 0 stands for no compensation at all, 1 stands for 100% compensation, and values upwards of 1 stand for excessive compensation, whereby the rotator is left further behind from the body's inclination direction, i.e. the lag tends to increase.

If the wave power plant is desired to be generating all the time, the compensation factor with a negative angle of lag can be left to be zero as the rotator is rotating in a clockwise direction (a positive speed), and a positive angle of lag can be multiplied with the ramp shown in FIG. 3B. Thus, the angle of lag (α_{LAG}) used in determining the compensation factor B is multiplied by a ramp type correction factor k, the value of which diminishes when passing from value 0 to value PI for the angle of lag. The correction factor k is preferably selected in such a way that a corrected compensation factor B k strives to drive the rotator to an angle of lag (α_{LAG}), which is within the range of ⅓ PI-½ PI. This is shown more precisely in FIG. 3C, wherein the compensation graph B k, which strives in ideal conditions to drive the rotator to a lag which corresponds to the intersection point of graphs present in FIG. 3C.

The multiplication factor k can be determined by using information obtained from a wave condition sensor 18 about the wave height. An optimum value for the multiplication factor k with regard to the wave height or other wave condition information can be searched experimentally.

In addition, the compensation adjustment can be improved by keeping the rotator speed close to a target speed, i.e. the speed corresponding to an average wave period. Therefore, the compensation factor B can be multiplied by a speed-dependent additional multiplication factor S, which is obtained by monitoring the rotator's angular velocity and the average wave period. The latter is obtained either directly from an acceleration sensor measuring accelerations of the body or from the separate wave condition sensor 18. FIG. 3D depicts an example of the speed-dependent additional multiplication factor S, which is for example a quadratic function.

Hence, the torque of a rotator capable of being compensated for by an electric machine (which at the same time is a moment that rotates the generator 7) is:

T(α_{LAG,}ω)=B(α_{LAG})·m·e·k(α_{LAG})·S(ω), when ω>0 (3)

This magnitude of moment, which changes non-linearly according to wave conditions, will be fed as an adjustment variable along a line 10 to the converter 8, which strives to maintain the moment at a value matching the adjustment variable.

Rotation of the rotator in a negative direction can be denied and a restart expedited thereby with the ramp presented in FIG. 3E. In this case, the moment to be fed to an electric machine is:

T=R·ω, when ω≦0. (4)

The compensation adjustment shall further involve the input of spinning wheel forces. This will be discussed next with reference to FIG. 4. In FIG. 4, the generator 7 is collective for both spinning wheel and mass rotator sections. The body's rotation speed, which is measured by an inertial sensor 21, is the earlier described gyrating motion. The inertial sensor 21 measures the body's rotation speed as components, i.e. rotations around x, y and z axes. (In this case, primarily around horizontal x and y axes and the z component can be disregarded). In a signal processing and computing unit (25) is established a resultant of x and y directed angular velocities (AVx and AVy) of the rotation speed and there is calculated an angular deviation (LAGgyro) between the established resultant angular velocity and a direction (α) of the rotator.

The mass forces are processed as described above. The spinning wheel forces are processed in a respective manner, but the Vx-y acceleration must be replaced with a rotation speed AVx-y of the body's inclination (from the inertial sensor 21), and the mass must be replaced with a spinning wheel force which is dependent on the spinning wheel's inertia I and rotating speed ωₛ. Thus, the compensation factor based on spinning wheel force is

$${B}_{AV} = \sqrt{{AV}_{x}^{2} + {AV}_{y}^{2}} \cdot {ω}_{spin} \cdot sin ( {LAG}_{gyro} ) \qquad ( 5 )$$

wherein

AV=an angular velocity of the body's rotary motion or gyrating motion, which is obtained from the inertial sensor 21. The square root expression is thus a resultant of the x and y directed angular velocities;

LAGgyro=an angular deviation between the AV resultant and a direction α of the rotator; and
ωₛ=a rotation speed of the spinning wheel.

The compensating moment for spinning wheel forces is obtained by multiplying a compensation factor B_{AV} with the spinning wheel's inertia I.

It should be noted that the lag LAGgyro used in the formula is calculated now from an angle between rotation vector (from the inertial sensor) of the body and the rotator direction.

What has been examined in the foregoing formulae is an absolute value of the compensation factor. This moment is delivered onto the control as counter to the direction of rotation as the rotator is rotating in a selected operating direction. Thus, the question is about generating. This applies also to a spinning wheel section as long as the spinning wheel has such a direction of rotation that the spinning wheel's top edge travels in a direction of rotation desired for the rotator.

If the use of compensation is desired in conditions other than those mentioned above, the sine rule present in formulae (1) and (5) can be marked with a minus sign. Thus, the question is not about generating but the running of a rotator as a motor, which can be used occasionally to improve the continuity of action.

The compensating moment for mass forces (including possible adjustment weighting) and the compensating moment for spinning wheel forces (including possible adjustment weighting) are finally summed up and delivered to the generator 7.

The moment arriving from a spinning wheel 24 at the shaft of the generator 7 is calculated from parameters of the spinning wheel. This moment can be delivered as a counter-torque to the generator 7 even the whole time in full. In this case, the lag is adjusted with a compensation factor of the mass rotator. If desired, the adjustability of the lag can be increased by calculating into the spinning wheel section's compensation factor a place-dependent increasing or decreasing multiplication factor in a manner similar to FIG. 1. In the adjustment diagram of FIG. 4, these possible additional adjustment multiplication factors can be calculated in a block 26. The spinning wheel's mass and all peripheral equipment present in the rotator function of course as “a mass” of the mass rotator section.

1. A method for adjusting the torque of a mass and gyro rotator in a wave power plant, said method comprising compensating partially or completely the torque of a rotator, which rotates around a vertical shaft, with a compensating moment which is produced by an electric machine, said method comprising measuring acceleration components for a given point of the wave power plant's floating body in directions perpendicular to each other as projected onto the rotator's plane of rotation, establishing a vector with a magnitude and direction for the measured acceleration components, monitoring the direction or angular position of a rotator and determining its lag from the direction of the acceleration components’ vector, and adjusting the compensating moment as dependent on a compensation factor whose sub-factors are the magnitude of the vector of the acceleration components of the body and the sine of the angle of lag wherein the method comprises adjusting the compensating moment not only as dependent on the compensation factor but also as dependent on a compensation factor based on spinning wheel forces, therefore comprising
using an inertial sensor to measure a rotation speed of inclination;
establishing a resultant of x and y directed angular velocities of the rotation speed;
calculating an angular deviation between the resultant angular velocity and the rotator's direction;
measuring the rotation speed of a spinning wheel;
establishing the spinning wheel section's compensation factor, based on spinning wheel forces, as a product whose factors are a spinning wheel rotation speed, the resultant of the x and y directed angular velocities of the body's inclination, and the sine of the aforesaid angular deviation; and determining a compensating moment for the spinning wheel section by multiplying the spinning wheel section's compensation factor with an inertia of the spinning wheel.

2. The method according to claim 1, wherein the rotator's rotation speed is striven to be kept constant by maintaining the compensating moment equal to the compensation factor

3. The method according to claim 1, wherein the compensation factor is multiplied with a multiplying factor, whereby factor 0 stands for no compensation at all, factor 1 stands for a 100% compensation, and factor values higher than 1 stand for an excessive compensation with the rotator's angle of lag increasing.

4. The method according to claim 1, wherein the angle of lag used in determining the compensation factor is multiplied by a ramp type correction factor whose value decreases when proceeding from value 0 to value PI of the angle of lag, and the correction factor is selected in such a way that a corrected compensation factor strives to drive the rotator to an angle of lag which is within the range of 1/3 PI- 1/2 PI.

5. The method according to claim 1, wherein the rotator's angular velocity and an average wave period are monitored and, in order to maintain the rotator's speed close to a target speed, i.e. the speed matching the average wave period, the compensation factor is multiplied with a speed-dependent additional multiplication factor.

6. The method according to claim 5, wherein the additional multiplication factor is a quadratic function whose value increases as the rotator's angular velocity increases.

7. The method according to claim 1, wherein the rotator's rotation in a negative direction is denied with a compensating moment.

8. A system for adjusting the torque of a mass rotator or a mass and spinning wheel rotator, said system comprising a wave power plant's floating body, a mass rotator rotating around a vertical shaft, and an electric machine which produces a compensating moment for compensating the rotator's torque partially or completely, an acceleration sensor used for measuring acceleration components for a given point of the wave power plant's floating body in directions perpendicular to each other as projected onto the rotator's plane of rotation, signal processing means used for establishing a vector with a magnitude and direction for the measured acceleration components, means used for monitoring a direction or angular position of the rotator, the signal processing means being adapted to determine a lag of the angular position from the acceleration vector's direction and said signal processing means are adapted to produce a compensation factor which is used for adjusting the compensating moment and whose sub-factors are the magnitude of the body's acceleration components and the sine of the angle of lag wherein the compensating moment is adapted to be adjusted not only as dependent on the compensation factor but also as dependent on a compensation factor based on spinning wheel forces, the system therefore comprising
an inertial sensor for measuring a rotation speed of the body's inclination;
a signal processing and computing unit for establishing a resultant of x and y directed angular velocities of the rotation speed and for calculating an angular deviation between the resultant angular velocity and the rotator's direction;
means for measuring the rotation speed of a spinning wheel;
the signal processing and computing unit (25) being adapted to establish a compensation factor, based on spinning wheel forces, as a product whose factors are a spinning wheel speed, the resultant of the x and y directed angular velocities of the body's inclination, and the sine of the aforesaid angular deviation.

9. The system according to claim 8, wherein the signal processing means include elements for multiplying the compensation factor with an adjustment factor which has an effect on the magnitude of the angle of lag.

10. The system according to claim 9, wherein the system includes means for monitoring the rotator's angular velocity and means for monitoring the average wave period, and that the signal processing means include elements for multiplying the compensation factor with an angular velocity-dependent additional, multiplication factor for maintaining the rotator's speed close to a target speed, i.e. the speed matching the average wave period.

11. The system according to claim 8, wherein more than 80% of the body's height is in submersion and the body is dimensioned to extend in vertical direction to such a depth where wave motion is essentially present, and that the acceleration sensor is located substantially flush with the plane of a trajectory of the rotator.
